(19) United States
(12) Patent Application Publication
(10) Pub. No.: US 2010/0241552 A1
(43) Pub. Date: Sep. 23, 2010

(54) Techniques for dynamically managing trading positions

(76) Inventors: Darren Boerner, Austin, TX (US); Jennifer Boerner, Austin, TX (US)

Correspondence Address: Darren Boerner, 4612 Avenue B, Austin, TX, 78751, US

(21) Appl. No.: 12/661,074

(22) Filed: Mar. 10, 2010

Related U.S. Application Data
(60) Provisional application No. 61/209,661, filed on Mar. 10, 2009.

(51) Int. Cl. G06Q 40/00

(52) U.S. Cl. 705/37

(57) ABSTRACT

Techniques to manage a position in a securities transaction. At least one embodiment pertains to adjust purchase and selling prices, as well as at least one target profit value to liquidate a plurality of positions dynamically and automatically.

### FIELD OF THE INVENTION

Embodiments of the invention relate generally to the field of information processing and securities trading and more specifically, to the field of dynamically managing one or more securities trading positions.

### BACKGROUND

As electronic securities trading continues to become popular in the United States and abroad, being able to react quickly and efficiently to small changes in market conditions and securities prices is growing increasingly important. In securities trading, the trader may create a position based on a purchase and/or sell price of one or more securities, the liquidation of which creates a profit through the security being transacted according to the difference between the purchase and the selling price.

Some prior art techniques for performing securities trading involves a trader creating a single purchase price target and/or a selling price target for one or more securities and performing that transaction only when the statically defined purchase and selling price criteria is met. However, the trader must typically adjust the selling and purchase prices of securities manually in reaction to a change in direction in the value of the securities being traded. Moreover, if the value of the security or securities being traded change in an unexpected manner, traders currently have no way to quickly respond to that change, but must manually define a new target buy and sell price, often resulting in lost revenue due to the latency involved in manually watching and reacting to price changes in securities.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a block diagram of a server/client-based securities trading system, in which at least one embodiment of the invention may be used.

FIG. 2 illustrates a flow diagram illustrating operations that may be used in conjunction with one or more embodiments.

FIG. 3 illustrates a graphical user interface for performing at least one embodiment of the invention.

### DETAILED DESCRIPTION

Embodiments of the invention are illustrated and described herein by way of example and are not intended to be an exhaustive list of all embodiments that could be used to perform aspects of the invention described herein. In general, embodiments include techniques to dynamically adjust multiple purchase and/or sell prices of one or more securities and at least one target profit for each position created by the purchase of each of the multiple purchases.

In at least one embodiment, one or more purchase prices, corresponding to an array of long positions, and corresponding one or more target profits may be specified by a user or securities trading program. In some embodiments, an array of selling prices, corresponding to an array of short positions, and a corresponding array of target profit values may be specified by a user or securities trading program. Whether an array of purchase prices (and corresponding long positions) or an array of selling prices (and corresponding short positions), or both, are specified, at least one embodiment enables a plurality of transactions to be completed without user intervention or control. In some embodiments, however, a user may dynamically change the purchase prices, sell prices, or target profits in each of their corresponding arrays in response to changing market conditions, such that multiple short and long positions may be changed or created, and subsequently transacted.

In some embodiments, an array of purchase prices and a corresponding array of sale prices are specified via graphical user interface (GUI) to a software application running on general purpose computing hardware, which has access to one or more servers of a securities exchange, such as the New York Stock Exchange. As the price of a security or securities matches the purchase prices specified in the purchase price array, or the selling prices specified in the selling price array, a specified security or securities are purchased (or sold) at the specified purchase or sell prices in the array. Furthermore as the price of the security or securities meet the target profit level or levels specified in a target profit field or array, the securities are automatically sold (in the case of a long position) or purchased (in the case of a short position) as each corresponding target profit is satisfied. In some embodiments, only one target profit is specified and that target profit corresponds to each purchase price specified in the purchase price array and/or each sell price specified in the sell price array. In other embodiments, a plurality of target profits may be specified, each corresponding to a different position created from each of the purchase prices in the purchase price array and/or each sell price specified the sell price array.

Some embodiments of the invention are intended to, among other things, allow a liquidating criteria to be maintained among one or more security positions with minimal user control or intervention, such that transactions may take place as quickly as possible. By allowing a user to specify one or more purchase and sell prices and one or more corresponding target profit values, embodiments of the invention can operate dynamically and automatically to yield the desired profit when each of the liquidating criteria are met. Furthermore, embodiments allow the purchase, sale, and/or profit targets to be updated real-time (i.e., during active trading), such that a user can react dynamically to changing market conditions. In some embodiments, a plurality of purchase prices or sell prices may be specified in their respective arrays. If a user creates a series of long positions by specifying a number of purchase prices and one or more target profit values for each position created, and the security begins to decrease in value beyond the range anticipated by the long positions created, a user may dynamically alter the purchase prices to liquidate his position or positions by specifying new purchase levels at new (lower) purchase prices equivalent to the value original position or positions. Likewise, if a plurality of short positions are created by specifying a number of selling prices in the selling price array, and the security increases in value beyond the scope anticipated by the short positions, a user may dynamically alter the selling prices in the selling array to liquidate his position or positions by specifying new selling prices at new (higher) selling levels equivalent to the value of the original position or positions.

For example, if a long position of 400 shares of a security is created by purchasing the 400 shares in one transaction at a purchase price of $5.00 and a target profit of $1.00 is specified, then at least one embodiment will sell the 400 shares when the security reaches $6.00. However, if the security declines in value (unexpectedly, for example), embodiments of the invention enable a user to specify an array of new purchase values (e.g., 100 shares at $4.00, 100 shares at $3.00, 100 shares at $2.00, and 100 shares at $1.00) with a target profit of $1.00 for each position. The newly specified positions, when transacted, will liquidate the original 400 shares purchased at $5.00 and a loss will be incurred. In this example, the position will be liquidated 100 shares at a time at price of $2.00, $3.00, $4.00 and $5.00). A similar technique may be used for short positions.

Embodiments of the invention may be applied equally to a single security, multiple securities, or pairs of securities. Furthermore, embodiments of the invention may enable faster control and liquidation of securities positions than in the prior art, thereby allowing the user to realize profit from smaller changes in the market. Embodiments of the invention, thus enable inefficiencies to be reduced in securities markets.

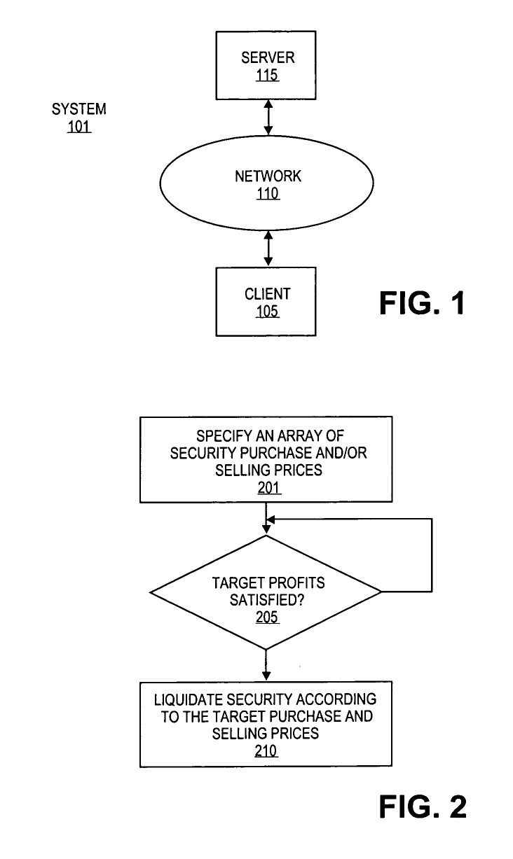

FIG. 1 illustrates a client/server-based securities trading system or network, in which one embodiment may be used. Particularly, FIG. 1 illustrates a system 101, including user client terminal 105, a network 110, and a server computer 115. In one embodiment, the server computer 115 provides market data to the user's client terminal 105 and is responsible for placing and completing buy and sell orders from the user's client terminal 105. The network 110 may be a private network or the world-wide web, in some embodiments. Furthermore, more servers or clients may be interface to the network than depicted in FIG. 1.

In one embodiment, the client 105 and/or the server 115 is running (and at least temporarily storing) a software program that implements one or more aspects of at least one embodiment of the invention. For example, the client 105 may be used to run a program and provide a user interface for performing dynamic spread management, according to various embodiments of the invention. In other embodiments, the server 115 is used to run such a program, whereas in other embodiments both the client and server include hardware and storage to run software that performs different aspects of some embodiments of the invention. In one embodiment, the client and/or the server includes general purpose or specialized hardware to perform aspects of embodiments of the invention.

In one embodiment, a user operating the client terminal illustrated in FIG. 1 can input an array of positions to be transacted, including purchase prices (for long positions) and selling prices (for short positions) and a target profit value or values for each position created.

Moreover, embodiments may work quickly and may only be limited in response time by the network delay, the client operational delay, and/or the server operational delay, thereby enabling a user to take advantage of very small fluctuations in securities prices that are presently un-harvestable by prior art security spreads trading techniques. As a result, embodiments of the invention help to create a more efficient securities exchange market.

FIG. 2 is a flow diagram illustrating operations that may be performed in at least one aspect of at least one embodiment of the invention. Other or additional operations may also be performed in other embodiments. Although in one embodiment, the operations illustrated in FIG. 2 are performed by a set of software instructions stored on a machine-readable medium, which when executed by a machine, such as a processor, perform a method comprising the operations illustrated in FIG. 2, in other embodiments, the operations illustrated in FIG. 2 may be performed in computer hardware, such as a general purpose or specialized processor. At operation 201, a user or user's proxy, such as a program, specifies an array of purchase and/or selling prices and corresponding target profit(s). If the security target profits are met at operation 205, then at operation 210, the security is liquidated according to the target purchase and selling prices.

In one embodiment, security (or securities) is (are) purchased at the purchase prices indicated in the purchase array when the security reaches that value in the security exchange in which the security is being traded (e.g., New York Stock Exchange), in one embodiment. Furthermore, in one embodiment, each position specified in the purchase or selling arrays are actually pairs or other multiples of securities.

In one embodiment, multiple secondary transactions may be scheduled or created with or without user intervention or control, but only in response to trade activity or securities values. In some embodiments, one or more positions (original or secondary) may be exited completely if after a certain amount of time or other condition the spread of the positions is not met. In one embodiment, one or more purchase prices and one or more corresponding selling prices, or one or more corresponding target profit points, may be specified and the program may act on these values automatically according to the price of the security or securities being traded. In other embodiments, a user may intervene and change the purchase and/or selling prices and/or target profits points at anytime or may cease trading altogether.

The following is a description of examples of how embodiments of the invention may be used. The examples discussed below are not intended to be an exhaustive list of how embodiments of the invention may be used, merely to illustrate one or more embodiments of the invention.

“Security” could refer a stock, bond, option, futures contracts or any other type of security. This can also refer to combinations of securities where you can assign a quantity and price to the combination. For example, this can be what's called a pair of securities (Security_A*Ratio_{—A} Security_B*Ratio_B). If you are long 1 unit of this security, then you are long Ratio_A units of Security_A and short Ratio_B units of Security_B. If you are short 1 unit of th security, then you are short Ratio_A units of Security_A and long Ratio_B units of Security_B. The price for this security will be Price=Price_A*Ratio_A−Price_B*Ratio_{—B} And Quantity=Quanity_A*Ratio_A. Security can also refer to widgets, screws, cows, etc. Anything where you can define a quantity and price. Or you can say that the price of the security is Price=Price_A/Price_B.

A Long Position is where you own a positive amount of the security and a Short Position is where you have sold a security that you do not own. For example, you could be short 1000 shares of IBM. If the price of IBM goes down, you can buy the position back in (so that your position is zero) for a profit. If the price of IBM goes up, you can buy the position back in for a loss.

When you are trading a security, you have a price where you will want to buy and/or sell the security. You may also have several prices where you will want to buy and/or sell the security. Furthermore, the prices where you will want to buy and/or sell a security may change based on your last trade. The Target Levels concept combined with the Target Profit (as well as a few other variables described later) is a system to easily manage these actions.

Lets assume that you have system that will try to trade a security based on a given buy and/or sell quantity & price inputs. The Target Levels concept provide these inputs. The inputs are determined from a set of Buy Target Levels (array), Sell Target Levels(array), Position (number) and Target Profit(number).

| | |
|---|---|
| Quantity | Price |

Sell Target Levels

| | |
|---|---|
| 1000 | 10.00 |
| 1000 | 9.00 |
| 1000 | 8.00 |

Buy Target Levels

| | |
|---|---|
| 1000 | 5.00 |
| 1000 | 4.00 |
| 1000 | 3.00 |

Target_Profit = 1.00

### EXAMPLE 1

If you are just starting to trade this security your Position is 0. So your buy price will be the highest buy price in the Buy Target Levels. So Buy_price=5.00, Buy_quantity=1000. Your sell price (sell short in this case) would be the lowest sell price. So, Sell_price=8.00, Sell_quantity=1000

### EXAMPLE 2

Suppose you bought 1000 shares of this security at 5.00. So your Position is now long 1000. The system will calculate your next buy price. It will refer to the Buy Target Levels and see that your highest buy level is for 1000 at 5.00. Since you are long 1000, the system knows that it will need to refer to the next highest price level for its buy information. So, Buy_price=4.00, Buy_quantity=1000.

Since your Position is long 1000, the system will not refer to the Sell Target Levels to find its sell price. Instead it refer to the Buy Target Levels to find the last level that you bought at and add the Target Profit to that level to calculate your sell level. So, the highest buy price is 5.00 with a quantity of 1000. The Target Profit is 1.00. Since you are long 1000, the system will try to sell that Position at 6.00 (5.00+1.00). So, Sell_price=6.00, Sell_quantity=1000.

### EXAMPLE 3

Instead assume your Position is short 1000 shares. Since you have a negative Position, the system will not refer to the Buy Target Levels to determine your buy price. It will refer to the Sell Target Levels. The lowest Sell Target Level price is 8.00 with a quantity of 1000. Since you are short 1000 and your Target Profit is 1.00, the system will set your buy price to 7.00 (8.00−1.00). Buy_price=7.00, Buy_quantity=1000.

To calculate your sell price, the system will refer to the lowest sell price in the Sell Target Levels. Since the lowest level has a quantity of 1000 (which is equal to your Position), the system will then refer to the next Sell Target Level which has a price of 9.00 and quantity of 1000. So, Sell_price=9.00, Sell_quantity=1000.

### EXAMPLE 4

Suppose you are short 1500 of the security. Using the similar logic as before, the system will calculate: Sell Price=9.00, Sell Quantity=500, Buy Price=8.00, Buy Quantity=500.

### EXAMPLE 5

The Buy Target Levels and the Sell Target Levels are the same. But assume a Target Profit of 0.7 and a Position of long 2300 of the security. So, Sell_price=3.7, Sell_quantity=300, Buy_price=3.00, Buy_quantity=700.

### EXAMPLE 6

Until now, we have varied the Position and the Target Profit to determine the current buy and sell levels. We can also change Buy Target Levels and the Sell Target Levels for a given position. Lets assume that are position is still long 2300 from the example before. But let us change the Buy Target Levels to:

Buy Target Levels

| Quantity | Price |
|---|---|
| 500 | 5.00 |
| 500 | 4.20 |
| 500 | 3.70 |
| 500 | 2.10 |
| 500 | 1.25 |

Let us also change the Target Profit to 1.4. If we are long 2300, the system will start from the highest Buy Target level and work down the target levels to find the lowest level where we are long from. The top four levels sum up to 2000 and the next levels is 500 at 1.25. So the system assumes we bought the first four levels (2000) and 300 of the last level (at 1.25). So our Sell Price is 1.25 plus our Target Profit of 1.4. So, Sell_price=2.65, Sell_quantity=300. And since we only bought 300 of the last level, Buy_price=1.25, Buy_quantity=200.

Now let us assume that we sell 300 so now our position is 2000. The system will refer to our Buy Target Levels and assume that we bought the first 3 levels (totaling 1500), as well as, the full fourth level (500 at 2.10). So, it will try to sell out of that levels at 2.10 plus the Target Profit of 1.4. So, Sell_price=3.5 Sell_quantity=500.

It will refer to the next buy level for its current buy level. So, Buy_price=1.25, Buy_quantity=500. It is important to know that the system will calculate the current buy and sell levels REGARDLESS of where we actually bought and sold the security. The calculated current buy and sell levels are SOLELY dependent on the Buy Target Levels, Sell Target Levels, Target Profit and Position.

Up until this point, we have assumed a constant Target Profit that is independent of the Buy Target Levels or Sell Target Levels. We can also assign a Target Profit per Target Level. So we could have:

| | | |
|---|---|---|
| quanity | Price | profit |

Sell Target Levels

| | | |
|---|---|---|
| 1000 | 10.00 | 3.00 |
| 1000 | 9.00 | 2.00 |
| 1000 | 8.00 | 1.00 |

Buy Target Levels

| | | |
|---|---|---|
| 500 | 5.00 | 1.00 |
| 500 | 4.00 | 2.00 |
| 500 | 3.00 | 3.00 |
| 500 | 2.00 | 4.00 |
| 500 | 1.00 | 5.00 |

### EXAMPLE 7

Suppose you are short 1500, so Position=−1500. The system will look to your Sell Target Levels. The system will assume that you sold the first sell level (1000) and 500 of the second level. So it will calculate your current sell as: Sell_price=9.00, Sell_quantity=500.

To calculate your buy price it will refer to the last level you sold (500 of the 1000 at 9.00). That sell levels Target Profit is 2.00. So it will try to buy that back with a 2.00 profit or a price of 7.00 (9.00−2.00). So, Buy_price=7.00, Buy_quantity=500. Furthermore, we can introduce 2 new variables: Highest_Exit_Buy_Price and Lowest_Exit_Sell_Price. Highest_Exit_Buy_Price will only apply to buying in a short position. And the Lowest_Exit_Sell_Price will only apply to selling out of a long position. These variables only affect the current buy and/or sell prices. They do not have any effect on the buy and/or sell quantities.

### EXAMPLE 8

Let us refer to the last example where we calculated our buy and sell levels to be Sell_price=9.00, Sell_quantity=500, Buy_price=7.00, Buy_quantity=500. In this example, our position was short 1500, or Position=−1500. Since we have a short position, the Lowest_Exit_Sell_Price does not apply. Let us assume that Highest_Exit_Buy_Price=5.00. Since this price is lower than our current buy_price, the system will then adjust the buy price to Buy_price=5.00.

### EXAMPLE 9

Suppose we are long a security and our calculated current sell level is Sell_price=6.00, Sell_quantity=1000. Since we are long the security, the Highest_Exit_Buy_Price does not apply. Suppose Lowest_Exit_Sell_Price=5.00. Since this is lower that our calculated current exit sell price, the system will adjust this to be Sell_price=5.00.

Embodiments of the invention may be used in various ways. For example, in one embodiment, the client terminal corresponds to an individual professional, or “series 7” trader and the server computer corresponds to a securities exchange, such as the New York Stock Exchange. In other embodiments, the client terminal corresponds to an institutional professional trading firm or individual. Irrespective of the nature or identity of the user, embodiments may be conveniently and simplistically operated through the use of a graphical user interface (GUI). In one embodiment, the GUI is associated with an application to perform embodiments of the invention and that runs within or in conjunction with a computer's operating system. In one embodiment, the GUI includes fields to input a purchase and selling price of one or more securities, corresponding to one or more spreads, of one or more original positions. The GUI may also include fields to indicate to a user the current price of a security, the status of his or her trades or positions, as well as other fields providing the user with real time market trends or news, as well as information about other positions the user might hold. Furthermore, in some embodiments, the GUI may provide a field for the user to exit the original or secondary positions, including a “stop target”, that indicates the price of a security or securities at which one or more positions are to be exited. In some embodiments, the GUI may include a “kill button”, which when activated causes one or more positions to be exited immediately, or as soon as possible.

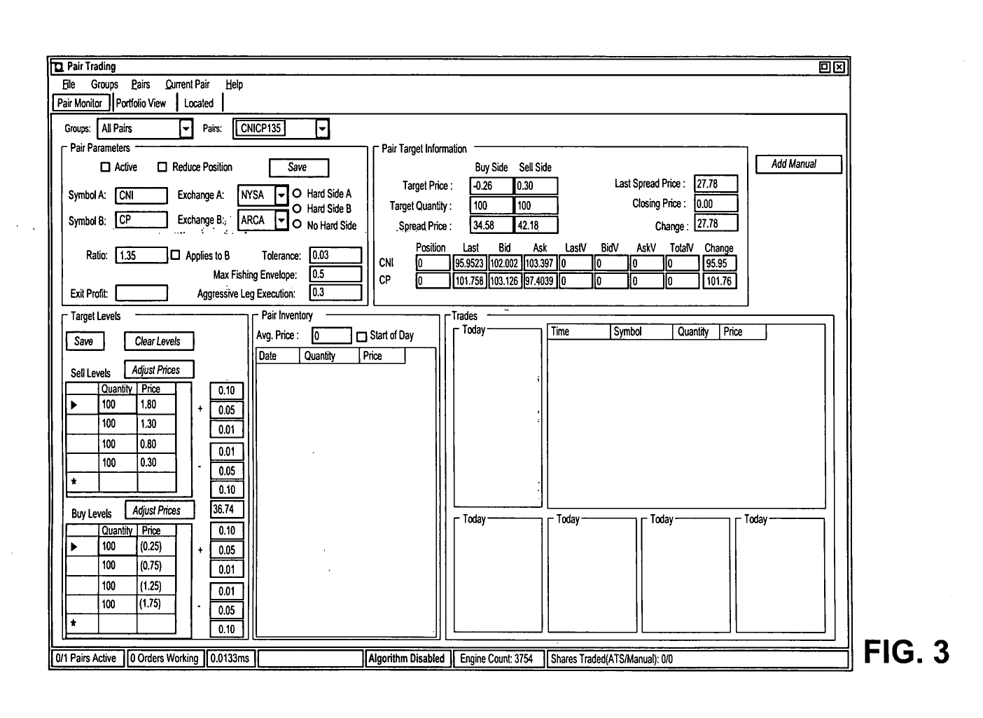

FIG. 3 illustrates a GUI, according to one embodiment. FIG. 3 illustrates a GUI with multiple fields and options for trading either individual securities at different purchase and selling points or pairs of securities with different purchase prices/spreads or selling prices/spreads. Furthermore, the GUI of FIG. 3 allows a user to choose securities sold on different exchanges. For example, a security pair could consist of one security from the New York Stock Exchange and a security from the American Stock Exchange. In one embodiment, the GUI consists of a set of securities pair parameter fields, including the securites pair symbols, the exchanges in which the securities pair is traded, a ratio of the securities pair prices, which to perform a sell transaction, an exit profit field, and other fields. The GUI, in one embodiment, may also include a pair target information area, including fields to indicate target buy and sell prices, target buy and sell quantities and target buy and sell spread prices. Furthermore, the pair target information may also include real-time (or near real-time) market data, including securities price, closing price, and price, change, as well as other fields, such as securities bid, ask, last price, position, and total change in price of the securities. Also included in the GUI, in one embodiment, are the sell and purchase target levels, which allow a user to input a number of purchase and corresponding selling target levels for one or more securities as well as the quantity to buy and sell. In one embodiment, the GUI may increase or decrease the target selling, purchase, or profit price by clicking on pre-defined “bump buttons”, which increment or decrement the target purchase, sale, and/or profit price according to pre-defined steps (e.g., $0.05).

One or more aspects of at least one embodiment may be implemented by representative data stored on a machine-readable medium which represents various logic within the processor, which when read by a machine causes the machine to fabricate logic to perform the techniques described herein. Such representations, known as “IP cores” may be stored on a tangible, machine readable medium (“tape”) and supplied to various customers or manufacturing facilities to load into the fabrication machines that actually make the logic or processor.

Thus, a method and apparatus for directing micro-architectural memory region accesses has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A machine-readable medium having stored thereon a set of instructions, which if performed by a computer system, causes the computer system to perform a method comprising:
storing a first plurality of transaction values corresponding to one or more securities;
storing a second plurality of transaction values corresponding to one or more securities;
causing the liquidation of the one or more securities in response to a plurality of conditions being satisfied, wherein each of the plurality of conditions corresponds to, one pair of transaction values comprising one of the first and one of the second plurality of transaction values.

2. The machine-readable medium of claim 1, wherein the first plurality of transaction values includes a plurality of purchase price targets of the one or more securities.

3. The machine-readable medium of claim 1, wherein the first plurality of transaction values includes a plurality of selling price targets corresponding to the one or more securities.

4. The machine-readable medium of claim 2, wherein the second plurality of transaction values includes a plurality of selling price targets corresponding to the one or more securities.

5. The machine-readable medium of claim 3, wherein the second plurality of transaction values includes a plurality of purchase price targets corresponding to the one or more securities.

6. The machine-readable medium of claim 2, wherein the second plurality of transactions includes one or more profit target values resulting from the liquidation of the plurality of securities.

7. The machine-readable medium of claim 4, wherein the plurality of conditions includes a price of at least one of the one or more securities being equal to at least one of the plurality of selling price targets.

8. The machine-readable medium of claim 5, wherein the plurality of conditions includes a price of the at least one or more securities being equal to at least one of the plurality of purchase price targets.

9. The machine-readable medium of claim 6, wherein the plurality of conditions includes the difference between a price of the at least one or more securities and at least one of the plurality of purchase price targets being equal to the one or more profit target values.

10. The machine-readable medium of claim 1, wherein the first and second plurality of transactions are to be specified by a user.

11. A method comprising:
storing a first plurality of transaction values corresponding to one or more securities;
storing a second plurality of transaction values corresponding to one or more securities;
causing the liquidation of the one or more securities in response to a plurality of conditions being satisfied, wherein each of the plurality of conditions corresponds to one pair of transaction values comprising one of the first and one of the second plurality of transaction values.

12. The method of claim 11, wherein the first plurality of transaction values includes a plurality of purchase price targets of the one or more securities.

13. The method of claim 11, wherein the first plurality of transaction values includes a plurality of selling price targets corresponding to the one or more securities.

14. The method of claim 12, wherein the second plurality of transaction values includes a plurality of selling price targets corresponding to the one or more securities.

15. The method of claim 13, wherein the second plurality of transaction values includes a plurality of purchase price targets corresponding to the one or more securities.

16. The method of claim 12, wherein the second plurality of transactions includes one or more profit target values resulting from the liquidation of the plurality of securities.

17. The method of claim 14, wherein the plurality of conditions includes a price of at least one of the one or more securities being equal to at least one of the plurality of selling price targets.

18. The method of claim 15, wherein the plurality of conditions includes a price of the at least one or more securities being equal to at least one of the plurality of purchase price targets.

19. The method of claim 16, wherein the plurality of conditions includes the difference between a price of the at least one or more securities and at least one of the plurality of purchase price targets being equal to the one or more profit target values.

20. The method of claim 10, wherein the first and second plurality of transactions are to be specified by a user.
